(19) United States
(12) Patent Application Publication
(10) Pub. No.: US 2011/0048767 A1
(43) Pub. Date: Mar. 3, 2011

(54) Twisted Pairs Cable with Tape Arrangement

(75) Inventors: Frederick W. Johnston, Dalton, NE (US); David J. Wiekhorst, Potter, NE (US)

(73) Assignee: ADC TELECOMMUNICATIONS, INC., Eden Prairie, MN (US)

(21) Appl. No.: 12/868,580

(22) Filed: Aug. 25, 2010

Related U.S. Application Data
(60) Provisional application No. 61/275,380, filed on Aug. 27, 2009.

(51) Int. Cl. H01B 11/02

(52) U.S. Cl. 174/116

(57) ABSTRACT

A multi-pair cable having a plurality of twisted conductor pairs and a tape arrangement. The tape arrangement providing a dielectric barrier between the twisted conductor pairs and a jacket of the multi-pair cable. The tape arrangement further defining at least two separate twisted pair regions in which the twisted conductor pairs lie.

### CROSS-REFERENCE TO RELATED APPLICATION

This application claims the benefit of U.S. Provisional Patent Application Ser. No. 61/275,380, filed Aug. 27, 2009, which application is hereby incorporated by reference in its entirety.

### TECHNICAL FIELD

The present disclosure relates generally to cables for use in the telecommunications industry. More particularly, this disclosure relates to a multi-pair cable for use in the telecommunications industry.

### BACKGROUND

A wide variety of cable arrangements having twisted conductor pairs are utilized in the telecommunications industry. In some cable arrangements, the twisted conductor pairs are separated by one or more filler components. The filler components occupy a volume that adds to the overall diameter of the cable.

In other arrangements, the cable includes shielding that surrounds the twisted conductor pairs, and the one or more filler components. Cable shielding is commonly provided in the form of a conductive tape. The conductive tape is wound around the outer diameter of the cable core in an overlapping manner.

In general, improvement has been sought with respect to existing cable assemblies, generally to reduce size of twist pair cables, reduce costs associated with twisted pair cables, and improve signal transmission performance of twisted pair cables.

### SUMMARY

The present disclosure relates to a multi-pair cable having a plurality of twisted conductor pairs and a tape arrangement. The tape arrangement includes foamed tape. In one aspect, the foamed tape both provides a dielectric barrier between the twisted conductor pairs and a jacket of the multi-pair cable, and defines at least two separate twisted pair regions in which the twisted conductor pairs lie.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a schematic, cross-sectional view of a first multi-pair cable, shown with a first tape arrangement, according to the principles of the present disclosure;

FIG. 2 is cross-sectional view of a foamed tape piece, according to the principles of the present disclosure;

FIG. 3 is a schematic, cross-sectional view of a second multi-pair cable, shown with a second tape arrangement, according to the principles of the present disclosure; and

FIG. 4 is a schematic, cross-sectional view of a third multi-pair cable, shown with a third tape arrangement, according to the principles of the present disclosure.

### DETAILED DESCRIPTION

Reference will now be made in detail to various features of the present disclosure that are illustrated in the accompanying drawings. Wherever possible, the same reference numbers will be used throughout the drawings to refer to the same or like parts.

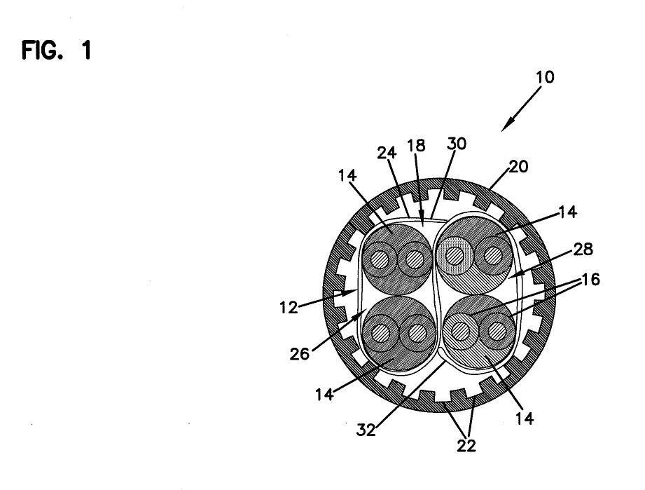

FIG. 1 schematically illustrates a multi-pair cable 10 including one embodiment of a tape arrangement 12 that is an example of how inventive aspects of the present disclosure may be practiced. Preferred features of the cable 10 and tape arrangement 12 include the reduction of electrical coupling characteristics and improvement of signal transmission performance.

Referring to FIG. 1, in general, the multi-pair cable 10 includes a plurality of twisted conductor pairs 14. Each of the twisted conductor pairs 14 includes two insulated conductors 16 twisted about one another along a longitudinal axis of the pair. The plurality of twisted conductor pairs generally defines a central cable core 18 of the cable 10. A jacket 20 surrounds the plurality of twisted conductor pairs 14 or central cable core 18.

In the illustrated embodiment, the jacket 20 is channeled to reduce material costs and/or provide a desired dielectric characteristic. In particular, internal channels 22 are formed on an inside diameter of the jacket 20. The channels 22 improve upon the dielectric characteristics of the jacket by providing a location for air to reside. The channels 22 also reduce the amount of material utilized in manufacturing the cable, and accordingly reduce the cost of the cable. The reduced amount of jacket material further correspondingly reduces the amount or propagation of flames and smoke, thereby enhancing the flame retardant quality of the cable 10. In one embodiment, the jacket 20 is made of a non-conductive material such as polyvinyl chloride (PVC), for example. Other types of non-conductive materials can also be used for the jacket, including other plastic materials such as fluoropolymers (e.g. ethylenechlorotrifluorothylene (ECTF) and flurothylenepropylene (FEP)), polyethylene, or other electrically insulating materials. In an alternative embodiment, the jacket can have a non-channeled construction.

While the cable 10 of FIG. 1 is illustrated with a first embodiment of the tape arrangement (e.g., 12), it is to be understood that the above general description of the cable 10 also applies to the cables having other tape arrangements described in detail hereinafter.

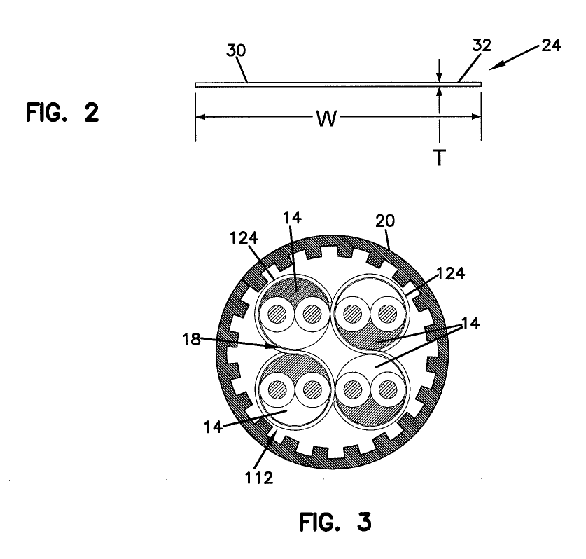

Still referring to FIG. 1, the tape arrangement 12 includes foamed tape 24. The foamed tape 24 is generally planar (see FIG. 2) but has a flexible construction. The foamed tape 24 completely surrounds the circumference of the cable core 18 such that the foamed tape 24 is located between the jacket 20 and each twisted pair 14. The foamed tape 24 provides a dielectric barrier between the twisted pairs 14 and the jacket 20 to aid in reducing cross-talk between cables.

In one embodiment, the foamed tape 24 is a flurothylenepropylene tape. In another embodiment, the foamed tape 24 is a polypropylene tape. In still another embodiment, the foamed tape 24 is a polyethylene tape. In some embodiments, the foamed tape 24 has a dielectric constant of about 1.7. Other electrically insulating materials can also be used. Referring to FIG. 2, the foamed tape 24 has a thickness T of about 0.005 inches to 0.010 inches. The air content of the foamed tape 24 generally ranges between about 15% and 35%; in one embodiment, the air content is about 25%. The tape arrangement 12 is preferably a non-conductive tape arrangement. In particular, no portion of the tape arrangement 12, i.e., the foamed tape 24, is conductive. The foamed tape 24 has instead the same uniform foam construction throughout the cross-section of the foamed tape.

In addition to providing a dielectric barrier between the twisted pairs and the jacket, the foamed tape 24 wraps around the twisted pairs 14 so as to define at least two separate twisted pair regions in which the twisted pairs lie. Separating or spacing apart the twisted pairs aids in reducing cross-talk between twisted pairs.

The tape arrangement 12 in FIG. 1 includes only the single piece of foamed tape 24. The single piece of foamed tape 24 has a width W (FIG. 2) extending from a first end 30 to a second end 32. The width W of the foamed tape 24 wraps around the twisted pairs in an S-shaped configuration. In FIG. 1, the S-shaped configuration of the single piece of foamed tape 24 separates a first set 26 of two twisted pairs from a second set of two twisted pairs. The width W of the foamed tape in FIG. 1 is between about 0.625 inches and 0.875 inches.

Each of the twisted conductor pairs 14 has a lay length, that is, a twist rate at which the two insulated conductors of the pair are twisted about one another. The plurality of twisted pairs 14 includes twisted pairs having longer lay lengths and twisted pairs having shorter lay length. For example, first and second twisted pairs 14 can have a longer lay length, and third and fourth twisted pairs 14 can have a shorter lay length. The longer and shorter lay lengths of the twisted pairs range between about 0.3 and 0.4 twists per inch. In one embodiment, the foamed tape 24 is arranged such that the first set 26 of two twisted pairs 14 includes one longer lay length twisted pair and one shorter lay length twisted pair, and the second set 28 of two twisted pairs also includes one longer lay length twisted pair and one shorter lay length twisted pair.

Referring now to FIG. 3, a second embodiment of a tape arrangement 112 is illustrated. In this embodiment the tape arrangement includes two pieces of foamed tape 124 that completely surround the cable core 18 and that define at least two separate twisted pair regions in which the twisted pairs 14 lie.

Similar to the previous embodiment, the two pieces of foamed tape 124 are each generally planar, and are flexible in construction. The pieces of foamed tape 124 each have a width that wraps around two twisted pairs 14 in an S-shaped configuration. The foamed tapes 124 wrap around the twisted pairs 14 to separate or divide the twisted pairs.

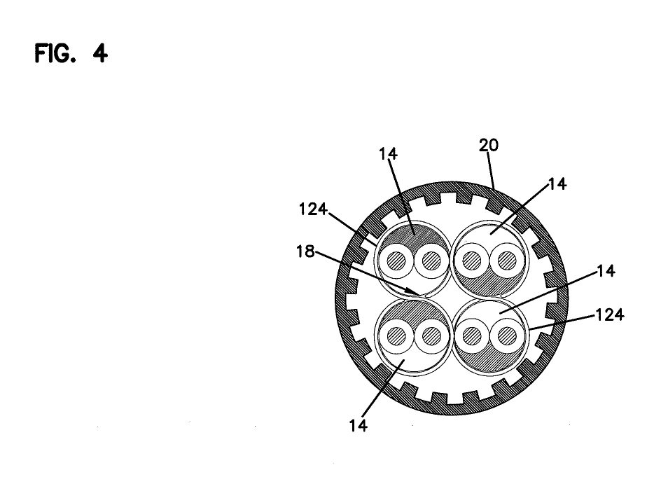

More specifically and referring to FIGS. 3 and 4, the two pieces of foamed tape 124 define four twisted pair regions that separate each twisted pair 14 from the other twisted pairs. In FIG. 3, the width of each foamed tape 124 is provided so as to completely surround the cable core 18 and completely surround two of the twisted pairs 14; in FIG. 4, the width of each foamed tape 124 is provided so as to completely surround the cable core 18 and completely surround all four of the twisted pairs 14. The width of each foamed tape 124 in FIGS. 3 and 4 is between about 0.375 inches and 0.625 inches.

The presently disclosed foamed tape arrangements provide for separation of the twisted pairs while reducing the overall diameter of the cable in comparison to conventional fillers. The reduced overall diameter is accomplished in part by the low profile (e.g., flatness) of the flexible foamed tape. In addition to providing separation, the flexible foamed tape also surrounds the cable core to function as a dielectric barrier having a significantly lower dielectric constant than that of conventional conductive shielding tape.

The above specification provides a complete description of the present invention. Since many embodiments of the invention can be made without departing from the spirit and scope of the invention, certain aspects of the invention reside in the claims hereinafter appended.

What is claimed is:

1. A multi-pair cable, comprising:
a) a plurality of twisted pairs that define a cable core;
b) a jacket that surrounds the plurality of twisted conductor pairs; and
c) a tape arrangement, including:
i) foamed tape completely surrounding the cable core such that the foamed tape is located between the jacket and each twisted pair to provide a dielectric barrier therebetween, the foamed tape further wrapping around the twisted pairs so as to define at least two separate twisted pair regions in which the twisted pairs lie.

2. The cable of claim 1, wherein the tape arrangement includes only a single piece of foamed tape that completely surrounds the cable core and defines the at least two separate twisted pair regions.

3. The cable of claim 2, wherein the single piece of foamed tape has a width that wraps around the twisted pairs in an S-shaped configuration.

4. The cable of claim 1, wherein the foamed tape wraps around the twisted pairs so as to separate a first set of two twisted pairs from a second set of two other twisted pairs.

5. The cable of claim 4, wherein the plurality of twisted pairs has longer lay length twisted pairs and shorter lay length twisted pairs, each of the sets of twisted pairs including one longer lay length twisted pair and one shorter lay length twisted pair.

6. The cable of claim 1, wherein the tape arrangement includes two pieces of foamed tape that completely surround the cable core and define the at least two separate twisted pair regions.

7. The cable of claim 6, wherein each twisted pair is completely surrounded by one of the two pieces of foamed tape.

8. The cable of claim 6, wherein the each piece of foamed tape has a width that wraps about two twisted pairs in an S-shaped configuration.

9. The cable of claim 1, wherein the foamed tape wraps around the twisted pairs so as to separate each twisted pair from the other twisted pairs.

10. The cable of claim 1, wherein the jacket has channels formed on an inside diameter of the jacket.

11. The cable of claim 1, wherein the foamed tape has a flexible construction.

12. The cable of claim 1, wherein the foamed tape includes flurothylenepropylene tape.

13. The cable of claim 1, wherein the foamed tape includes polyethylene foamed tape.

14. The cable of claim 1, wherein the tape arrangement is a non-conductive tape arrangement.
